(19) United States
(12) Patent Application Publication
(10) Pub. No.: US 2024/0217746 A1
(43) Pub. Date: Jul. 4, 2024

(54) WOODEN LONG PRODUCT SORTING DEVICE

(71) Applicant: Hans Hundegger Beteiligungs GmbH & Co. KG, Pfronten-Weißach (DE)

(72) Inventor: Hans HUNDEGGER, Hawangen (DE)

(73) Assignee: Hans Hundegger Beteiligungs GmbH & Co. KG, Pfronten-Weißach (DE)

(21) Appl. No.: 18/401,828

(22) Filed: Jan. 2, 2024

(30) Foreign Application Priority Data
Jan. 2, 2023 (DE) 10 2023 100 029.2

(51) Int. Cl. B65G 15/08; B07C 3/08

(52) U.S. Cl. CPC B65G 15/08; B07C 3/08; B65G 2201/0282

(57) ABSTRACT

A wooden long product sorting device for the automated distribution and transfer of the longer wooden components, such as beams, boards or bars, processed in a woodworking plant to different trays or receptacles. In order to enable automatic sorting also of longer wooden components with reduced space requirements, the wooden long product sorting device has two or more receiving and transfer devices arranged side by side and parallel to each other, which include a component support that can be pivoted between a horizontal receiving position and a folded-up transfer position.

### FIELD OF THE INVENTION

The invention relates to a wooden long product sorting device for the automated distribution and transfer of the longer wooden components, such as beams, boards or bars, transported from a woodworking plant to different trays or receptacles.

### BACKGROUND

In woodworking, the problem often arises that several longer wooden components machined consecutively on a processing machine have to be assigned to different orders after processing. The beams, boards or bars coming from the processing machine must then be transported to different trays or receiving devices after processing in order to distribute them to different production orders or production lots, for example. This can be done, for example, by a transportation belt arranged on the processing machine that can be tilted to either side. This allows the workpieces lying on the transportation belt to be dropped to either side and collected in trays or receptacles located there for further transport. However, if the workpieces have to be assembled into more than two orders, several successive transportation belts are needed, which requires a large amount of space that is often not available, especially for long components.

### SUMMARY

One aspect of the invention relates to a sorting device for wooden long products of the type mentioned above, which enables automated sorting of even longer wooden components with reduced space requirements and improved distribution.

Expedient embodiments and advantageous further embodiments of the invention are disclosed herein.

The wooden long product sorting device according to the invention includes two or more receiving and transfer devices arranged side by side and parallel to each other, which include a component support that can be pivoted between a horizontal receiving position and a folded-up transfer position. The receiving and transfer devices, which are arranged side by side and have the component supports that can be swiveled between a horizontal receiving position and a folded-up transfer position, allow longer and also shorter wooden components to be transferred transversely to their longitudinal axis and distributed automatically to different trays or receptacles in a particularly space-saving manner. This allows space-saving sorting and distribution of wooden components in the transverse direction. In the horizontal receiving position, the component support can cover a receptacle arranged below and a wooden component can be received in the longitudinal direction for transfer. In the folded-up transfer position, the component support can release a receptacle arranged below for sorting the wooden component, or a wooden component lying on the component support can be transferred to a receiving and transfer device arranged next to it for sorting into further receptacles. By moving the component supports into the tilted transfer position, a wooden component lying on the component support of a first receiving and transfer device can either be transferred to the component support of the further receiving and transfer device arranged next to it, which is in a horizontal receiving position, or dropped into a receptacle arranged next to it, provided that the component support of the receiving and transfer device arranged next to it is in the folded-up transfer position. The wooden long product sorting device is of simple design and can be extended as required by further receiving and transfer devices of identical design.

In one possible embodiment, the mutually parallel receiving and transfer devices can be arranged on one or both longitudinal sides of a transportation device designed for transferring the wooden components to a first receiving and transfer device. By means of the transportation device, the wooden components can be transported, for example, transversely to their longitudinal axis either into a first receptacle or for further transport onto the component support of a first receiving and transfer device. The transportation device can be designed, for example, as a transportation belt with a conveyor belt that can be driven in the longitudinal direction and tilted to the side. By driving the conveyor belt in the longitudinal direction, a wooden component coming from a processing station can first be transported in the longitudinal direction to a specific position and then transported in the transverse direction, depending on the position of the component support, either into a first receptacle arranged next to the transportation device or onto the component support of a first receiving and transfer device for transfer to a further receptacle. However, the wooden components can also be transferred to a component support of a first receiving and transfer device by means of transverse sliders, grippers or other suitable transportation devices.

However, the wooden components can also be transferred to a component support of a first receiving and transfer device by means of transverse sliders, grippers or other suitable transportation devices. The transportation device can also be designed, for example, as a roller conveyor with separate transport elements for the longitudinal movement of the wooden component and transverse sliders for pushing the wooden component off the roller conveyor in the transverse direction. The wooden components can also be transported by hand or by robots or other automatic handling devices from a processing machine to the component support of a first receiving and transfer device for further sorting.

In order to be able to accommodate workpieces of different lengths without difficulty, the component support can advantageously be designed as a continuous bearing plate with a rectangular upper bearing surface. However, the component support can also be formed by several supports spaced apart from one another. The distances between the supports can be selected so that wooden components of different lengths can be received and transferred.

In a constructively and manufacturingly simple design, the component support can be arranged on a horizontal longitudinal beam parallel to a longitudinal axis of the transportation device so as to be pivotable about a horizontal axis of rotation. The horizontal longitudinal beam can be supported on vertical supports that are spaced apart from one another.

To enable the wooden components to be transferred to the component supports of the receiving and transfer devices as gently and smoothly as possible, the component supports have an upwardly curved rounding on their freely projecting first longitudinal side and an upwardly curved ramp on their opposite second longitudinal side. Due to the ramp, it can be prevented in the horizontal receiving position of the component support that a wooden component sliding during the transfer onto the component support slides sideways beyond the component support. In the folded-up transfer position of the component support, the ramp enables a rounded transition to a component support arranged next to it.

The receptacles arranged on the right and left longitudinal sides of the horizontal longitudinal beams on both sides of the receiving and transfer devices can, in a practical design, be constructed as a stake car with a transport carriage in the form of a flat car and retaining posts or stakes inserted on the sides of the transport carriage pointing upwards to secure the load against sliding down. Ropes or tarpaulins can be arranged between the stakes to protect the wooden components dropped into the receptacles from damage. Of course, other receptacles or trays can also be provided for automated removal of the sorted wooden components.

### BRIEF DESCRIPTION OF THE DRAWINGS

Further features and advantages of the invention will be apparent from the following description of a preferred embodiment based on the drawing. It shows:

FIG. 1 a schematic view of a wooden long product sorting device with a transportation device and several receiving and transfer devices in a perspective view:

FIG. 2 a schematic top view of the wooden long product sorting device of FIG. 1:

FIG. 3 the wooden long product sorting device shown in FIG. 1 with the receiving and transfer devices in a first position in a sectional view along line A-A of FIG. 2 and

FIG. 4 the wooden long product sorting device shown in FIG. 1 with the receiving and transfer devices in a second position in a sectional view along line A-A of FIG. 2.

### DETAILED DESCRIPTION

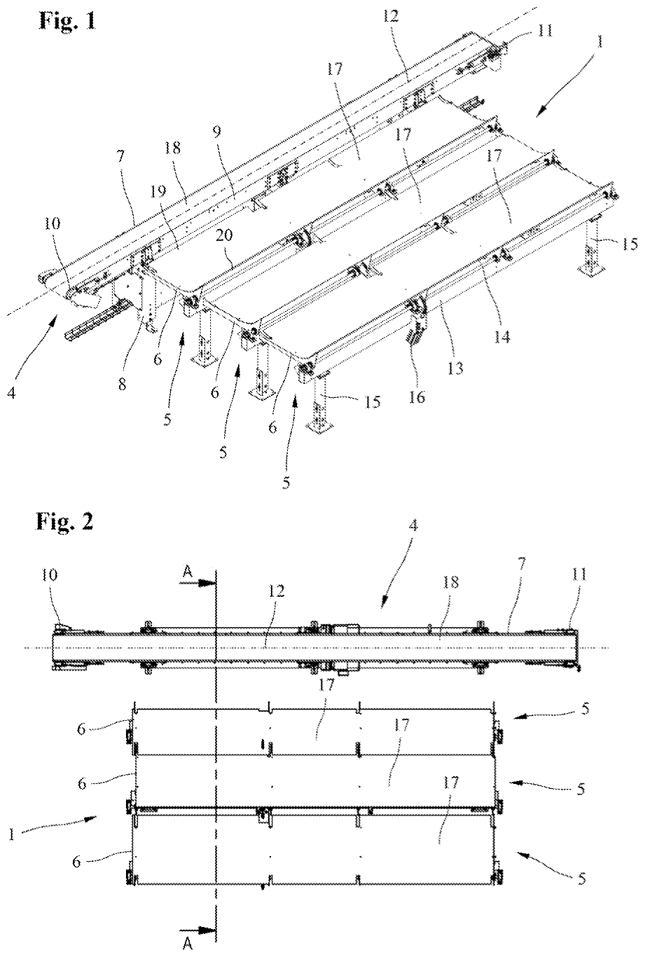

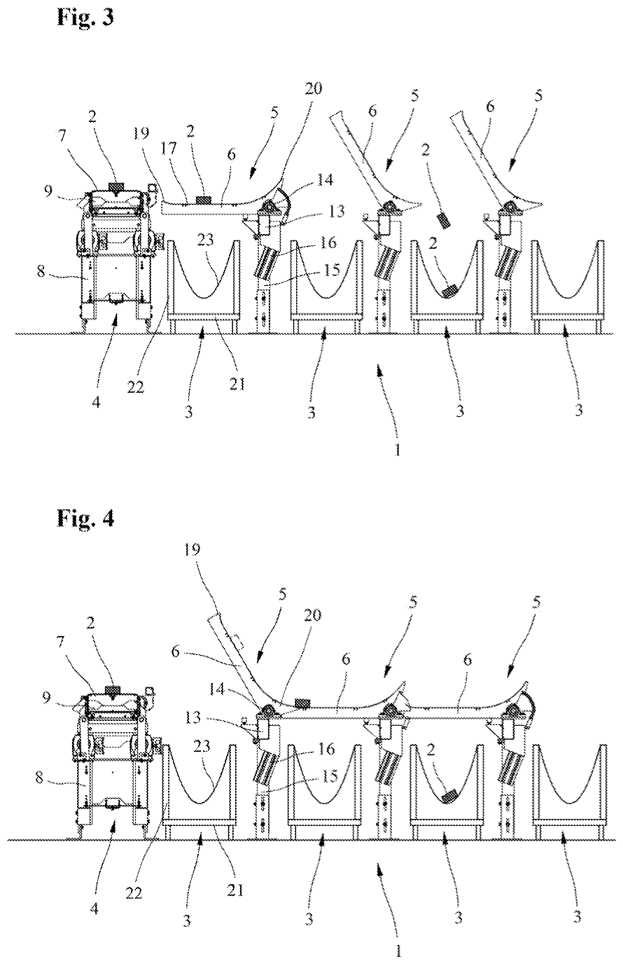

The wooden long product sorting device 1 shown in various views in FIGS. 1 to 4 is designed for the automated distribution and transfer of the longer wooden components 2, such as wooden beams, boards or bars, removed from a processing plant to a plurality of receptacles 3 arranged side by side. With the aid of the shown wooden long product sorting device 1, the wooden beams, boards, bars or similar long wooden components 2 processed in a woodworking plant can be automatically distributed transversely to their longitudinal axis in a particularly space-saving manner to a plurality of receptacles 3 shown in FIGS. 3 and 4 and combined to form desired production units. In FIGS. 3 and 4, the wooden long product sorting device 1 with several receptacles 3 designed here as transport carriages is shown in different transfer positions as a sectional view.

In the embodiment shown, the wooden long product sorting device 1 contains several receiving and transfer devices 5 arranged next to a transportation device 4 in parallel to the latter and to each other, which have a plate-shaped component support 6 that can be pivoted between a horizontal receiving position and a folded-up transfer position. The transportation device 4 designed for longitudinal and transverse transportation of a wooden component 2 is designed here as a transportation belt with a conveyor belt 7 that can be driven in the longitudinal direction and tilted to the side. With the aid of the conveyor belt 7 of the transportation device 4, which can be tilted between a horizontal conveying position and a transfer position tilted to the side, a wooden component 2 coming from a processing station can be moved in the longitudinal direction and, by tilting the conveyor belt 7, subsequently transported in the transverse direction, depending on the position of the component support 6, either into a first receptacle 3 arranged next to the transportation device 4 or onto the component support 6 of a first receiving and transfer device 5 arranged next to the transportation device 4. The transportation device 4 with the conveyor belt 7, which can be driven in the longitudinal direction by means of a drive mechanism, has a length corresponding to the length of the plate-shaped component support 6, so that even the longest wooden components 2 can be transferred from the transportation device 4 centrally onto the plate-shaped component support 6 of the first receiving and transfer device 5.

As can be seen from FIGS. 3 and 4, in the version shown there, two further receiving and transfer devices 5 are arranged next to the first receiving and transfer device 5 and parallel to it and to each other. By means of these, the wooden components 2 transported away transversely from the transportation device 4 can be distributed to further receptacles 3. By means of three receiving and transfer devices 5 arranged side by side, the wooden components 2 discharged laterally by the transportation device 4 can thus be distributed to four different receptacles 3. The wooden long product sorting device 1 can be extended as desired by further receiving and transfer devices 5. Insofar as the transportation device 4 designed as a transportation belt contains a conveyor belt 7 that can be tilted to both sides, corresponding receiving and transfer devices 5 can also be arranged on both longitudinal sides of the transportation device 4.

In the embodiment shown, the transportation device 4, which is generally arranged on a processing unit of a woodworking plant and is designed for transporting away the processed wooden components 2 in the direction of their longitudinal axis, contains a substructure 8 formed from vertical and horizontal profiles, on which a support structure 9 is arranged for guiding and driving the conveyor belt 7, which is guided via front and rear deflections 10 and 11. The support structure 9 is arranged on the substructure 8 so that it can tilt to either side, so that a wooden component 2 lying on the conveyor belt 7 can be discharged by tilting to either side. Of course, the support structure 9 can also be arranged fixedly on the substructure 8 and the wooden components 2 can be discharged laterally from the conveyor belt 4 by separate discharge elements or the like. The transportation device 4 does not necessarily have to be designed as a transportation belt either. It can also be designed, for example, as a roller conveyor with separate transport elements for the linear movement of the wooden components lying on the roller conveyor.

As can be seen from FIG. 1, the component supports 6 of the receiving and transfer devices 5 arranged alongside the transportation device 4 are arranged on horizontal longitudinal beams 13 running parallel to a longitudinal axis 12 of the transportation device 4 so as to be pivotable about a horizontal axis of rotation 14. The longitudinal beams 13, which are spaced apart from and parallel to the transportation device 4, are supported at their ends by two spaced-apart vertical supports 15. The component supports 6, which extend over a large part of the total length of the transportation device 4, can be swiveled between the horizontal receiving position and the folded-up transfer position by means of a drive mechanism 16 in the form of a pneumatic cylinder.

In the embodiment shown, the component supports 6 are designed as continuous bearing plates with a rectangular upper bearing surface 17. In the horizontal receiving position, the component supports 6 project laterally from the longitudinal beam 13 in the direction of the transportation device 4 and the upper bearing surface 17 is arranged slightly below an upper bearing surface 18 of the conveyor belt 4.

As can be seen from FIGS. 3 and 4, the first receiving and transfer device 5 arranged next to the transportation device 4 is positioned in such a way that a wooden component 2 sliding down from the bearing surface 18 of the conveyor belt 7 as a result of tilting of the latter reaches the component support 6 of the first receiving and transfer device 5, provided that the component support 6 of the first receiving and transfer device 5 is in the horizontal receiving position as shown in FIG. 3. If, on the other hand, the component support 6 of the first receiving and transfer device 5 is in the folded-up position as shown in FIG. 4, a wooden component 2 sliding down from the bearing surface 18 of the conveyor belt 7 as a result of tilting of the latter can fall into the first receptacle 3 arranged next to the transportation device 4.

If the component support 6 of the second receiving and transfer device 5 arranged next to the first receiving and transfer device 5 is in the folded-up transfer position as shown in FIG. 3, a wooden component 2 arranged on the component support 6 of the first receiving and transfer device 5 can be conveyed into the second receptacle 3 arranged laterally next to the first receptacle 3 by folding up the component support 6. If, on the other hand, the component support 6 of the second receiving and transfer device 5 arranged next to the first receiving and transfer device 5 is in the horizontal transfer position as shown in FIG. 4, a wooden component 2 arranged on the component support 6 of the first receiving and transfer device 5 can slide onto the component support 6 of the second receiving and transfer device 5 by folding up the component support 6 of the first receiving and transfer device 5. The third receiving and transfer device 5 or further receiving and transfer devices arranged next to the second receiving and transfer device 5 can then be used for a corresponding distribution to further receptacles 3.

To enable the wooden components 2 to be transferred to the component supports 6 of the receiving and transfer devices 5 as gently and trouble-free as possible, the component supports 6 have an upwardly curved rounding 19 on their freely projecting first longitudinal side and an upwardly curved ramp 20 on their opposite second longitudinal side. In the horizontal receiving position of the component support 6, the ramp 20 can prevent a wooden component 2 sliding onto the component support 6 from sliding laterally beyond the component support 6. In the folded-up transfer position of the component support 6, the ramp 20 enables a rounded transition to a component support 6 arranged next to it. In the folded-up position of the component support 6, the ramp 20 covers the freely projecting longitudinal side of an adjacent component support 6 located in the horizontal receiving position and forms a rounded transition surface.

In the version shown, the receptacles 3 arranged on both sides of the receiving and transfer devices 5 are designed as stake cars with a transport carriage 21 designed as a flat carriage and retaining posts or stakes 22 inserted on the sides of the transport carriage 21 and pointing upwards to secure the load against sliding down. Ropes or tarpaulins 23 are arranged between the stakes 22 to protect the wooden components 2 dropped into the receptacles 3 from damage.

### LIST OF REFERENCE SIGNS

1 Wooden long product sorting device
2 Wooden component
3 Receptacle
4 Transportation device
5 Receiving and transfer device
6 Component support
7 Conveyor belt
8 Substructure
9 Support structure
10 Front deflection
11 Rear deflection
12 Longitudinal axis of the transportation device
13 Horizontal longitudinal beam
14 Horizontal axis of rotation
15 Vertical support
16 Drive mechanism
17 Upper bearing surface of the component support
18 Upper bearing surface of the conveyor belt
19 Rounding
20 Ramp
21 Transport carriage
22 Stake
23 Rope or tarpaulin

1. A wooden long product sorting device for automated distribution and transfer of a longer wooden components, such as beams, boards or bars, processed in a woodworking plant, to different trays or receptacles, the wooden long product sorting device comprising two or more receiving and transfer devices arranged side by side and parallel to each other, which include a component support pivotable between a horizontal receiving position and a folded-up transfer position.

2. The wooden long product sorting device according to claim 1, wherein the mutually parallel receiving and transfer devices are arranged on one or both longitudinal sides of a transportation device designed for transferring a wooden component to a first receiving and transfer device.

3. The wooden long product sorting device according to claim 1, wherein the transportation device is designed as a transportation belt with a conveyor belt that can be driven in the longitudinal direction and tilted to the side.

4. The wooden long product sorting device according to claim 1, wherein the component supports are designed as a continuous bearing plate with a rectangular upper bearing surface.

5. The wooden long product sorting device according to claim 1, wherein the component supports are each arranged on a horizontal longitudinal beam so as to be pivotable about a horizontal axis of rotation.

6. The wooden long product sorting device according to claim 5, wherein the horizontal longitudinal beam is supported on vertical supports spaced from each other.

7. The wooden long product sorting device according to claim 1, wherein the component supports have an upwardly curved rounding on a freely projecting first longitudinal side.

8. The wooden long product sorting device according to claim 7, wherein the component supports include an upwardly curved ramp on a second longitudinal side opposite the freely projecting first longitudinal side.

9. The wooden long product sorting device according to claim 8, wherein the ramp in the folded-up position of the component support covers the freely projecting longitudinal side of a component support arranged next to it and being in the horizontal position.

10. The wooden long product sorting device according to claim 5, wherein the receptacles are arranged on right and left longitudinal sides of the horizontal longitudinal beams.

11. The wooden long product sorting device according to claim 1, wherein the receptacles are designed as stake cars with a transport carriage designed as a flat carriage and retaining posts or stakes inserted on sides of the transport carriage pointing upwards.

12. The wooden long product sorting device according to claim 11, wherein ropes or tarpaulins are arranged between the retaining posts or stakes.
